(19) United States
(12) Patent Application Publication
(10) Pub. No.: US 2014/0156442 A1
(43) Pub. Date: Jun. 5, 2014

(54) SYSTEMS AND METHODS FOR SERVICE TRANSACTIONS AND CHARITABLE DONATIONS

(71) Applicant: CHANGE THE WORLD CORPORATION, Great Falls, VA (US)

(72) Inventors: Kenneth CUSHING, Great Falls, VA (US); Jessica BALIK, Bethesda, MD (US); Saad EL BELEIDY, McLean, VA (US); Mihai RAUTA, North Bethesda, MD (US)

(73) Assignee: CHANGE THE WORLD CORPORATION, Great Falls, VA (US)

(21) Appl. No.: 13/692,405

(22) Filed: Dec. 3, 2012

(51) Int. Cl. G06Q 30/06

(52) U.S. Cl. CPC G06Q 30/0611
USPC 705/26.4

(57) ABSTRACT

Methods, systems, and computer program products are disclosed that provide an online marketplace for services from vendors. The method includes providing to service vendors a request for a service that a customer creates on the system. Further, the method includes receiving bids from the service vendors in response to the request for the service. The method further includes receiving a selection of one of the bids from the customer. The method further includes providing a payment to a selected vendor corresponding to the selected one of the bids.

The present invention relates to online marketplaces for services.

### BACKGROUND

Conventional markets that offer services require customers to identify service vendors, contact the service vendors, and work out details of a purchase transaction for the vendors' services. However, such interactions are inefficient for both the customers and the vendors. Moreover, absent time-consuming research, the customers may lack detailed information upon which they can differentiate between vendors having substantially equal qualifications.

### SUMMARY

In a first aspect of the invention, a method provides an online marketplace for services from vendors. The method includes providing a request for a service from a customer to service vendors. The method further includes receiving bids from the service vendors in response to the request for the service. The method further includes receiving a selection of one of the bids from the customer. The method further includes providing a payment to a selected vendor corresponding to the selected one of the bids.

In another aspect of the invention, a system provides an online marketplace for services from vendors. The system includes a computing system having one or more computing devices communicatively linked via an information network. The one or more computing devices provide a request for a service from a customer to service vendors. Further, the one or more computing devices receive bids from the service vendors in response to the request for the service, wherein one or more of the bids indicate a mutual relationship with the customer in an online social network. Further, the one or more computing devices receive a selection of one of the bids indicating the mutual relationship for purchase. Further, the one or more computing devices complete the purchase of the service.

In an additional aspect of the invention, a computer program product includes a computer usable storage medium having program code stored on a computer-readable storage device that, when executed by one or more computing devices, control the one or more computing devices to receive bids from service vendors in response to a request for a service from a customer. One or more of the bids indicates a mutual relationship with the customer in an online social network. Further, the program code, when executed by one or more computing devices, controls the one or more computing devices to receive from the customer a selection of one of the bids indicating the mutual relationship for purchase. Further, the program code, when executed by one or more computing devices, controls the one or more computing devices to post information associated with the purchase to a representation of the mutual relationship in one or more online social networks.

### BRIEF DESCRIPTION OF THE DRAWINGS

The present invention is described in the detailed description that follows, in reference to the noted plurality of drawings by way of non-limiting examples of exemplary embodiments of the present invention.

FIG. 1 shows an exemplary environment for implementing the processes and steps in accordance with aspects of the invention.

FIG. 2 shows a flow diagram of an exemplary bidding process for a service request via an online service marketplace in accordance with aspects of the present invention.

FIG. 3 shows a flow diagram of an exemplary process for issuing and using coupons in an online service marketplace in accordance with aspects of the present invention.

FIG. 4 shows a flow diagram of exemplary processes providing charitable campaigns in an online service marketplace in accordance with aspects of the present invention.

### DETAILED DESCRIPTION

The present invention relates to online marketplaces for services. In implementations, a customer accesses an online marketplace and requests bids for services. Aspects of the invention generate a request for a service for the customer that elicits bids from vendors via the online marketplace. The customer may select one of the vendors' bids using a reverse auction managed by the online marketplace. Alternatively, the customer may select one of the vendors' bids and directly purchase its services via the marketplace (i.e., “direct buy”) without selection from an auction.

Further, according to aspects, the invention enables customers and/or vendors to make charitable donations to non-profit organizations (“NPOs”) and other charitable causes, both within transactions for services made through the online marketplace, and independently of such transactions. In embodiments, the online marketplace aggregates non-profit organizations, charitable organizations, and causes, and allows customers to choose the ones to which they would like to donate. Customers and/or vendors can donate some or all of the payment for a purchased service to a selected non-profit organization, charitable organization, or cause. Additionally, aspects of the invention enable the customers and/or vendors to associate information of the services requested and/or purchased via the online marketplace with their social, vocational, and philanthropic interests to build online relationships connecting customers, vendors, and/or organizations having common interests and goals.

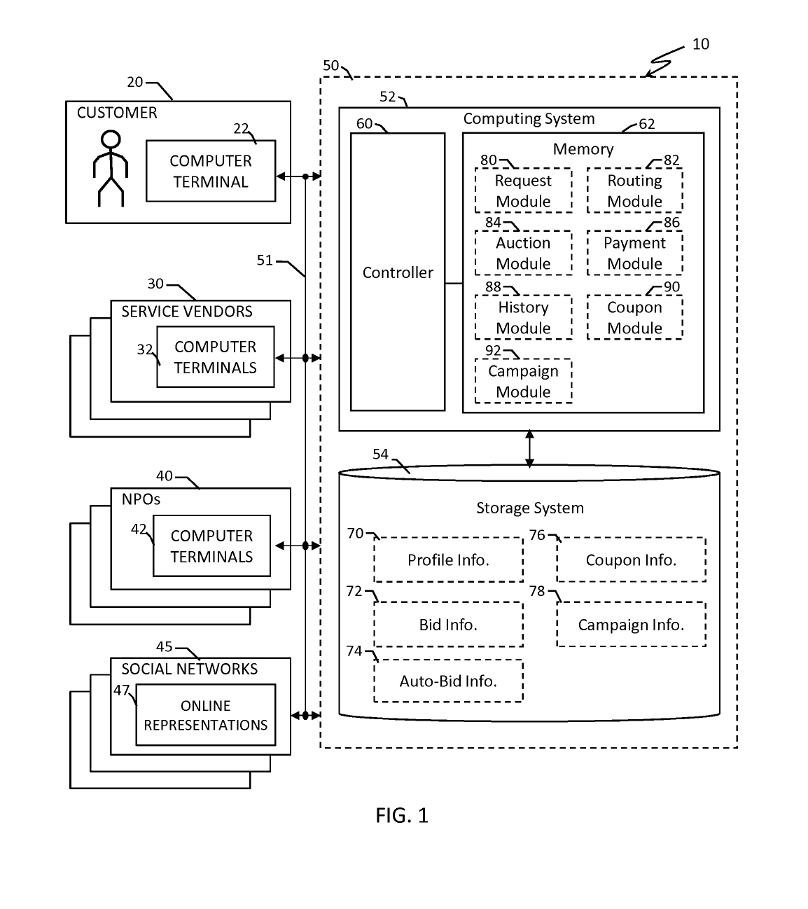

FIG. 1 is a block diagram illustrating an exemplary environment 10 in accordance with aspects of the invention. The environment 10 is only one example of a suitable environment that can be provided for implementing aspects of the invention and is not intended to limit the scope of the disclosed embodiments. The environment 10 includes a customer 20, service vendors 30 (i.e., “vendors”), and non-profit organizations 40 communicatively linked with a host 50 by respective computer terminals 22, 32, and 42. Additionally, the environment 10 can include one or more online social networks 45 that are communicatively linked to the customer 20, the vendors 30, the non-profit organizations 40, and/or the host 50. It should be recognized that FIG. 1 illustrates a single customer 20 interacting with a number of vendors 30, non-profit organizations 40 and/or online social networks 45; however, the depiction of the single customer 20 is for the sake of example and implementations of the environment 10 can include a large number of customers that each can interact with the vendors 30, the non-profit organizations 40 and/or the online social networks 45 directly or through the host 50 using respective computer terminals (such as computer terminal 22).

The customer 20 and the vendors 30 can be any type of entity, including individuals, business entities, government agencies, charitable organizations, and the like. For example, the customer 20 may be a homeowner in need of a repairperson, or the customer 20 may be a business in need of landscaping services. The vendors 30 are entities that provide commercial services including, for example, a hairstylist, a babysitter, a housecleaning service, a roofing company, etc. The non-profit organizations 40 can be any non-profit organization, including charities (e.g., “501c organizations”), religious groups, foundations, causes, and the like. The non-profit organizations can include, for example, a church, a school, or a charitable foundation. The foregoing entities are only examples of customers 20, vendors 30, and non-profit organizations 40. These examples are not intended limit the sizes or regional scope of those entities. For example, the vendors and the non-profit organizations can be individual, local, national, or global entities.

The computer terminals 22, 32, 42 can be any programmable computing devices that exchange information with the host 50 over communication channels 51. For example, the computer terminals 22, 32, 42 may include thin clients, personal computers (e.g., desktop or laptop), tablet computers, smart phones, personal digital assistants, mobile telephones, and the like. The computer terminals 22, 32, 42 may include a processor, memory, a data storage device and stored program instructions that control the computer terminals 22, 32, 42 to receive and display information for the customer 20, the vendors 30, and the non-profit organizations 40.

In embodiments, the computer terminals 22, 32, 42 execute program instructions that control the terminals to receive, process, and/or distribute service requests, bids, payments, or coupons. Additionally, the computer terminals 22, 32, 42 execute program instructions that control the terminals to exchange information with one another, the host 50, and the online social networks 45 via the one or more communication channels 51. Further, the computer terminals 22, 32, 42 execute program instructions that control the terminals to provide graphical-user interfaces presenting the information to respective users (i.e., customer 20, and vendors 30) in accordance with the processes disclosed herein. The program instructions may be a dedicated software application incorporating the functionality of the processes described herein. The program instructions may be located and/or entirely within the computer terminals 22, 32, 42 (e.g., a local application), they may be located and/or executed remotely from the computer terminals 22, 32, 43 (e.g., by the host 50 a web application), or a mix thereof in which components of the program instruction are located and/or executed within the terminals 22, 32, 42 and the remaining components are located and/or executed remotely (e.g., by the host 50).

In accordance with aspects of the invention, the online social networks 45 can be any online service for social or professional networking. The online social networks 45 may allow members (which may include the customer 20, the vendor 30, and the non-profit organization 40) to establish online representations 47. The online representations 47 may be, for example, profiles, webpages, bulletin boards, virtual reality and/or game avatars, groups, clubs, etc. The relationships are links between two online representations 47 established by mutual agreement of the members. Via online representations 47, the members may selectively share information. Additionally, the online social networks 45 may allow members having linked online representation to identify and access information of some or all of one each others' links to other members. Moreover, the online social networks 45 may identify mutual relationships, which are relationships that are common to linked members (e.g., a shared friend or coworker). Also, based on mutual relationships between linked members of the online social networks 45, the online social networks 45 may notify members of other members with which they are associated but are not linked (e.g., friends-of-friends, schoolmates, coworkers, etc.). In this way, a member may build an online network of relationships with members that have similar relationships, backgrounds, vocational and philanthropic interests, causes, etc.

In accordance with aspects of the invention, relationships established by customers 20, vendors 30, and non-profit organizations 40 via their representations 47 in online social networks 45 established are leveraged for mutual benefit. For instance, the customer 20 may evaluate bids for services from vendors 30 based on relationships the vendors 20 have in common with the customer's 20 relationships (e.g., ratings and recommendations from mutual relationships) or non-profit organization's 40 that the customer 20 supports. Additionally, vendors 30 may obtain work, jobs, contacts, advertising and goodwill (e.g., ratings, referrals) by supporting non-profit organizations 40 that are also supported by its customers (e.g., customer 20). Further, non-profit organizations (e.g., non-profit organizations 40) may support vendors 30 (e.g., through coupons and campaigns) by driving work to the vendors 30 while generating donations for themselves.

In accordance with aspects of the invention, the host 50 is one or more devices or systems of a service vendor that supplies an online service marketplace to the customer 20, the vendors 30, and the non-profit organizations 40. The host 50 can be implemented as one or more computer systems including, for example, a personal computer, a minicomputer, a microprocessor, a server, a workstation, a mainframe, or a similar computing platform.

Communication between the customer 20, the vendors 30, the non-profit organizations 40, and/or the online social networks 45 can be performed via the communication channels 51. The communication channels 51 may be wired and/or wireless connections. In some instances, the communication channels 51 can be a direct link such as an analog, a serial, or a parallel interface. In other instances, the communication channels 51 can be a shared, public, private, or peer-to-peer network, encompassing any wide or local area network such as an extranet, an intranet, the Internet, a Local Area Network (LAN), a Wide Area Network (WAN), a private network (VPN), a voice over internet packet network (VoIP), a public switched telephone network (PSTN), an Integrated Services Digital Network (ISDN), or any other form of wired or wireless communication network.

The host 50 includes a computing system 52 and a storage system 54. The computing system 52 is, for example, one or more personal computers, servers, minicomputers, mainframes, and the like. As shown in FIG. 1, the computing system 52 includes a controller 60 and a memory 62. The controller 60 can include one or more processors, read-only memory (ROM), random access memory (RAM), a clock, a communication interface, a data bus, input/output devices, user-input devices, and a display device. The memory 62 can include removable/non-removable, volatile/non-volatile computer program storage devices. The memory stores 62 program modules including computer-executable instructions that perform the functions and/or processes in accordance with the embodiments described herein. Additionally, although not shown, the memory 62 may store an operating system and application programs (e.g., an Internet browser), other program modules, and program data. The computer-executable instructions can be encoded using any suitable computer programming language such as PHP, C++, JAVA, and SCALA.

The storage system 54 is any hardware thereof that stores computer-executable instructions (e.g., software, firmware, applications, programs, code, portions of code, and combinations thereof) and data (e.g., data compilations, databases, data sets) that, when retrieved and processed by controller 60, control the computing system 52 to perform the functions and/or processes of embodiments described herein. The storage system 54 may include, for example, a semiconductor, a magnetic or an optical-based information storage/retrieval device (e.g., flash memory, hard disk drive, CD-ROM, flash RAM). Although the storage system 54 is depicted as a single element, the storage system 54 may comprise any additional number of storage media. Further, although the computing system 52 and the storage system 54 are illustrated as being within the host 50, this location is merely exemplary. The computing system 52 and the storage system 54 can be physically located inside or outside of the host 50. For instance, the storage system 54 can be configured as a network accessible storage device located remotely from the computing system 52.

The storage system 54 can contain user profile information 70, bid information 72, auto-bid information 74, coupon information 76, and campaign information 78. The profile information 70 is information describing the users of the host 50 (i.e., customer 20, vendors 30, and non-profit organizations 40), including identification information, contact information (e.g., telephone number, e-mail address, etc.), descriptions (e.g., type, demographics, location, credentials, recommendations, etc.), payment information (e.g., bank account information, credit information, invoices, and history, etc.), history information (e.g., transactions, ratings, donations, and online social network posts of a user, etc.), and social media information (e.g., associated online social networks, online social network memberships, representations, relationships, etc.). The bid information 72 is information received from the vendors including, e.g., a type of bid (e.g., buy-it-now, continuous), a price or a range of prices of a bid, a description, conditions, and a donation amount. The auto-bid information 74 includes pre-established bid information provided by the vendors 30, including, e.g., price, time, location, etc. The coupon information 76 includes a description of a coupon that may be offered by a vendor or non-profit organization, including a discount amount, a deadline for using the coupon, and routing criteria for the coupon. The campaign information 78 includes information describing operator (e.g., a non-profit organization), participants (e.g., customers and vendors), and associated online social networks.

In general, the controller 60 processes data (e.g., 70, 72, 74, 76, 78, etc.) and executes computer program code (e.g., modules 80, 82, 84, 86, 88, 90, ad 92, etc.), which can be stored in the memory 62 and/or the storage system 54. In accordance with aspects of the invention, a request module 80 controls the computing device 62 to present a computer-user interface at the computer terminal 22 of the customer 20 (e.g., via fillable form including predefined menu selections and/or text-entry boxes), receive a request for a service (e.g., criteria, requirements, restrictions), retrieve user information (e.g., name, address, payment and relationships), and combine the information to generate a service request that is provided to a routing module 82. In embodiments, the customer 20 provides terms corresponding to requirements and restrictions for the service request that is used to route the request to one or more of the vendors 30. In implementations, the terms provided by the customer are unconstrained. That is, the terms provided by the customer are extensible such that the terms are not limited to a number or type. For example, the request module 80 may use natural language data analysis techniques and predefined dictionaries of terminology to parse terms included in the customer's 20 request for services into requirements and restrictions for inclusion in the service request.

The routing module 82 controls the system 52 to match the customer 20 with one or more of the vendors 30 based on information included in the service request (e.g., service criteria, customer requirements, customer restrictions, user information, payment information, relationship information, etc.). In embodiments, the routing module 82 selects vendors 30 to receive the service request based on a match between the vendor's information (e.g., stored in profile information 70) and requirements (e.g., type, subtypes, location, and time of service, etc.) specified in the service request. Further, the routing module may filter the selected vendors based on restrictions included in the service request (e.g., time frames, costs, customer preferences). Additionally, in accordance with aspects of the invention, the routing module 82 may select vendors 30 to receive the service request based on matches between relationship information of the vendors 30 and the customer 20. For example, the routing module 82 may select vendors based on the vendors' 30 mutual relationships with relationships of the customer 20 in the online social networks 45. Also, the routing module 82 may provide bids received from the selected vendors 30 to an auction module 84 for presentation and selection by the customer 20.

The auction module 84 controls the computing system 52 to present received bids to the customer 20 and perform an auction process (e.g., a reverse auction) between the vendors 30 based on their bids. For example, in a reverse auction, the auction module 84 varies the bids based on predetermined thresholds determined by the vendors 30. Additionally, in implementations, the auction module 84 adds relevant transaction fees for a given bid. For example, perhaps a hairdresser entered a bid of $20, and at that price, there are transaction fees including a $2 service fee and a $2 credit card processing fee. The auction module 84 at the customer's 20 computer terminal 22 would display the bid as $24, not $20.

The payment module 86 controls the computing system 52 to transfer payments and/or donations between the customer 20, the vendors 30, and the non-profit organizations 40. For example, the payment module 86 transmits payments for services from a customer to a vendor via a third-party payment gateway, which handles credit-card transactions. The payments may be in the form of currency, credit, and/or coupons. Further, the payment module 86 transmits donations to a selected one of the non-profit organizations 40 from the customer 20 and/or the vendors 30 via the third-party payment gateway. In embodiments, the payment module 86 attributes the transaction fees through the third-party payment gateway to the customer 20 and/or vendor 30 such that 100% of the donation amount is provided to the selected one of the non-profit organizations 40.

The history module 88 controls the computing system 52 to store and/or update information related to the transactions performed by the host. For example, the history module 88 may store historical information of purchases of the customer 20, vendors 30 and non-profit organizations 40 in the profile information 70. In accordance with aspects of the invention, the history module 88 automatically provides information related to a transaction to respective representations of the customer 20, vendors 30 and non-profit organizations 40 in corresponding online social networks 45. For example, based on information stored in profile information 70, the history module 88 may post information related to a transaction (e.g., parties, service, donation, ratings, etc.) to online representations 47 of a customer, a vendor, and a non-profit organization involved in the particular transaction. By doing so, relationships of the parties to the transaction in one or more of the online social networks 45 may informed of the transaction (including any donations and recommendations). Additionally, the history module 88 may post a description of the transaction to the online representations of entities (e.g., friends, relationships, businesses, non-profit organizations, etc.)

In accordance with further aspects of the invention, a coupon module 90, when executed by the controller 60, controls the host 50 to generate and/or issue coupons to select users of the online service marketplace (e.g., customer 20 and non-profit organizations 40). In embodiments, the coupon module 90 provides a computer-user interface at, for example, the computer terminals 32 of the vendors 30 through which the vendors 30 can generate coupons. For example, a vendor 30 may submit information for a coupon, including a discount amount, a deadline for using the coupon, and routing criteria for the coupon, which may be stored in coupon information 76 in association with the vendor's profile stored in profile information 70. Further, in accordance with aspects of the invention, the coupon module 90 identifies potential customers of a vendor based on profile information 70 of the potential customers (e.g., demographics, purchase histories, relationships) stored in storage system 54. For example, the coupon module 90 may match a vendor to potential customers based on demographics, purchase histories, donation histories, mutual relationships, etc. Thus, the vendors 30 can use information of potential customers from online social networks 45 to direct coupons based on mutual relationships, associations, interests, histories philanthropy, etc. Additionally, the coupon module 90 receives the vendors' 30 selection of potential customer to receive the coupon and distributes it to the potential customers via the computer terminals 22 and/or the online representations 47 of the potential customers.

In accordance with further aspects of the invention, a campaign module 92, when executed by the controller 60, controls the host 50 to generate and distribute fundraising campaigns for the non-profit organizations 40. A campaign may be directed to an entire organization or a specific cause (e.g., disaster relief for a particular storm). In accordance with further aspects of the invention, the campaign module 92 provides a computer-user interface at, for example, the computer terminals 42 of the non-profit organizations 40 through which the non-profit organizations 40 generate campaigns. For example, a non-profit organization may submit information for a campaign, including a description, a deadline for contributions, and a goal and routing criteria for the coupon, which may be stored in campaign information 78 in association with the non-profit organizations' profile stored in profile information 70. Further, in accordance with aspects of the invention, the campaign module 92 identifies potential vendors 30 to participate in the campaign based on profile information 70 of the potential vendors. For example, the campaign module 92 may match a non-profit organizations 40 to potential contributors based on demographics, purchase histories, donation histories, mutual relationships, etc. Thus, the non-profit organizations 40 can use information of potential vendors from online social networks 45 to direct campaigns to vendors 30 that may be willing to donate funds and or services based on mutual relationships, associations, interests, histories philanthropy, etc. Vendors 30 may donate funds or services directly to the campaign via the host (e.g. as donations or free services). Additionally or alternatively, the vendors 30 may donate a portion of the proceeds from services provides to customers (e.g., customer 20) to the campaign. Additionally, the campaign module 90 receives the vendors' 30 selection of potential customer to receive the coupon and distributes it to the selected vendors via the computer terminals 32 and/or the online representations 47 of the selected vendors.

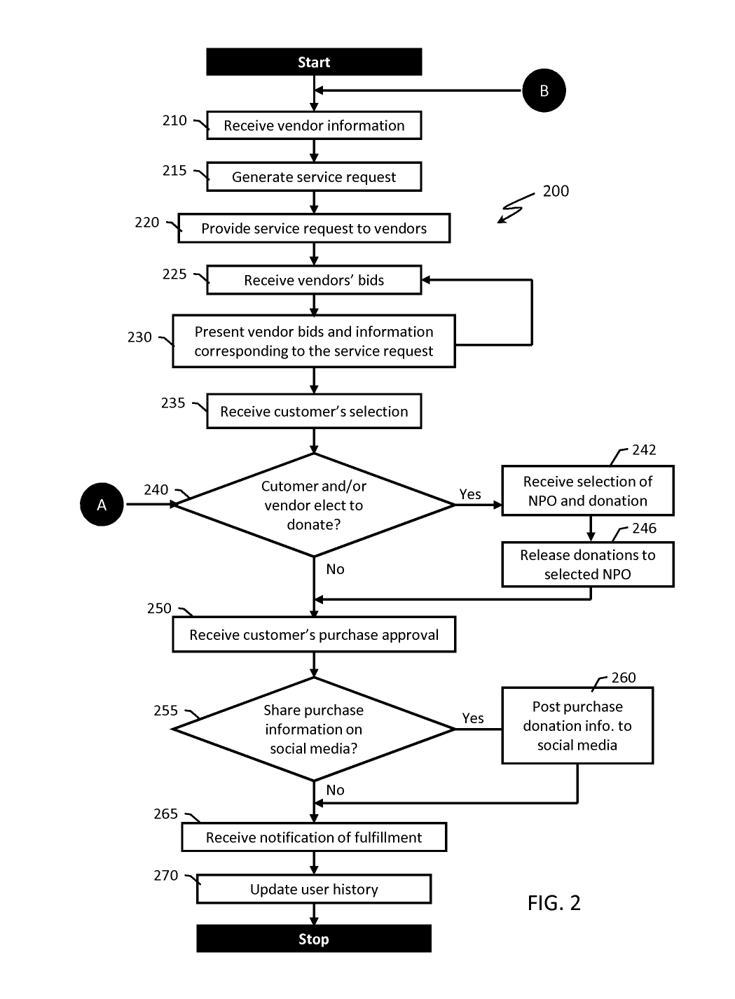

FIGS. 2-4 show exemplary process flow diagrams depicting process in accordance with aspects of the invention. The steps of the process flow diagrams can be implemented in the environment of FIG. 1, for example. The process flows illustrate the functionality and operation of implementations of systems, methods, and computer program products according to various embodiments of the present invention. Each block in the flow diagrams can represent a module, segment, or portion of code, which includes one or more computer-executable instructions for implementing the disclosed functionality. It should also be noted that, in some alternative implementations, the functions in the blocks may occur in different order than that depicted in the process flow diagrams. For example, two blocks shown in succession may be combined, executed substantially concurrently, or executed in the reverse order, depending upon the functionality involved.

FIG. 2 shows a flow diagram 200 of an exemplary process for bidding for a service request in accordance with aspects of the invention. According to embodiments disclosed herein, a customer (e.g., customer 20) of an online service marketplace (e.g., host 50) can generate a service request for one or more vendors (e.g., vendors 30) and/or donate to a charitable organization (e.g., non-profit organizations 40). At step 210, the online service marketplace receives information from vendors (e.g., from vendors 30 via computer terminals 32). The vendor information can include information about the vendors (e.g., name, location, description, credentials, etc.) and the services each vendor offers (e.g., type, cost/rate, geographic range, etc.) via the online service marketplace. Additionally, according to aspects of the invention, the vendor information includes relationship information (e.g., identifications and/or links to relationships and/or associations on online social networks).

In embodiments, the vendor information is provided as part of a registration process. The registration process may record a profile (e.g., profile information 70) for each vendor that uses that online service marketplace to offer services to customers. For example, a vendor may offer housekeeping service and, accordingly, the vendor may provide information corresponding to its service including, for example, name, address, contact information, service area, availability, prices, and references. Further, the vendor may maintain one or more representations (e.g., online representations 47, such as profiles, webpages, and/or groups) at one or more online social networks (e.g., online social networks 45). The vendor's online representations at the one or more online social networks may be associated with information identifying the vendor's relationships and associations. For example, the vendor's representation may be associated with representations of various individuals (e.g., customer 20), other vendors (e.g., vendors 30), and non-profit organizations (e.g., non-profit organizations 40).

At step 215, the online service marketplace, via a request module (e.g., request module 80), generates a service request (i.e., a request for bids) for a customer (e.g., customer 20). For example, the request module may create the service request based on information provided by the customer by filling out a predefined form presented on a graphic user interface by a personal computer (e.g., computer terminal 22). The form can include entries for customer information (identification information, contact information, address information, relationship information), requirements (e.g., type of service, date, time, location information, price, donation, etc.) and restrictions (e.g., vendor type, size, distance from location of service, relationships, preferences, etc.) In embodiments, the customer is a registered user of the online service marketplace (e.g., host 50) that accesses the service using a login process. In such case, some or all of the customer information may have been previously stored in a user profile (e.g., as profile information 70 in storage system 54) and this information may be automatically incorporated or associated with a service request.

For example, a customer's service request may include requirements for a haircut service with a certain geographical radius from his home address, and on a particular date with a restriction that a hairstylist be a male. In implementations, the request module only requires the customer to provide a few (e.g., three) parameters that describe the request; however, the customer can provide additional requirements and restrictions.

At step 220, the request module provides the customer's service request to a selection of registered vendors with the online service marketplace (e.g., vendors 30). The vendors can be selected by a routing module (e.g., routing module 82) which compares information included in the customer's service request received at step 215 to the information received from the vendors received at step 210. For example, the online service marketplace provides the service request to vendors that match the customer's requirements for service (e.g., hairdresser or synonymous terms), location (e.g., at 20 mile range from the customers' address or closer), and availability date (e.g., weekends or the like). Additionally, the online service marketplace may limit the selected vendors based on the customer's restrictions (e.g., preferences for philanthropic vendors, gender of service vendors, mutual relationships, or associations with the customer, etc). Moreover, in accordance with aspects of the invention, the service request incorporates relationship information (e.g., membership in a group of a cause hosted by a non-profit organization 40 in one of online social networks 45).

In implementations, the routing module compares the information included in the customer's service request with vendor profile information and identifies a set of the vendors whose profiles include information in the customer's service request. Based on this determination, the routing module provides the service request to the identified vendors to elicit bids. In implementations, the routing module may identify vendors to receive a service request when the vendor's profile includes a predetermined amount of the terms required in the customer's service request, but lacks information with respect to another term (e.g., all but one, or more than 80% of the requirements).

In embodiments, the routing module may request additional information from a vendor concerning the requirements of the customer's service request. For example, a hairdresser's profile may not indicate a gender. In such case, the routing module may initiate contact (e.g., an email) with those vendors and request the missing information. Alternatively, the routing module may inform a human representative of the online service marketplace to contact the vendor by, e.g., initiating a chat (e.g., via the host 50).

At step 225, the online service marketplace, via an auction module (e.g., auction module 84), receives bids from one or more of the vendors that had been provided the service request at step 220. As bids are received, the information may be stored by the auction module (e.g. as bid information 72 in the storage system 54). In accordance with aspects of the invention, the vendors can manually submit their bids, one bid at a time, via a computer-user interface presented by the auction module to the vendors on a computing device (e.g., computer terminal 32) that is communicatively linked to the online service marketplace (e.g., host 50). Additionally or alternatively, the auction module allows vendors to provide continuous bids. For example, a hairdresser may choose to place a manual bid for the haircut at a certain price (e.g., using computer terminal 32). Alternatively, the hairdresser may choose to specify an opening bid and a minimum price for which he is willing to provide the haircut, and the online service marketplace can, thereafter, automatically and repeatedly bid progressively lower prices for the hairdresser, similar to a reverse auction process.

Vendors may provide bids manually or automatically (i.e., auto-bid) in response to the online service marketplace providing a service request. Auto-bidding enables vendors to automatically provide bids in response to a service request by pre-establishing bids with the online service marketplace. In embodiments, the auction module retrieves auto-bids (e.g., auto-bid information 74) stored in association with a vendor's profile information (e.g., profile information 70). Alternatively, the vendors' auto-bids can be stored on a vendor device (e.g., computer terminals 32) and received by the auction module. As a result, the vendors that pre-establish auto-bids can be free from waiting and/or watching for incoming services requests and entering a bid (as in the manual case). Additionally, because vendor's bids can be provided automatically, a customer that provides a service request can receive bids immediately in response to a request without waiting for vendors to manually provide bids.

At step 230, the auction module (e.g., auction module 84) provides the customer with bids received from the vendors at step 225 and information corresponding to the customer's request. For example, the auction module presents a display of the vendors' bids and related information to the customer via a computer-user interface provided on a display of a computing device (e.g., computer terminal 22). In the event the routing module selects a vendor having an auto-bid, the online service marketplace (e.g., via routing module 82) may retrieve the bid in response to the service request. In implementations, any retrieved auto-bids that satisfy the requirements of a customer's service request are immediately provided by the online service marketplace for presentation to the customer, as depicted at step 230. Any additional bids (auto-bids or manual bids) are then presented as they are received. The process iteratively repeats until the customer chooses to purchase an already received bid or, otherwise, cancels the service request (e.g., by manually selecting an option to cancel the service request or automatically after a predetermined period of time passes without the customer selecting a bid).

The auction module may present received bids in a sorted manner on the customer's computing terminal (e.g., computer terminal 22) that the most relevant is displayed first. For example, bids of vendors who are geographically closer to the customer can be prioritized in a display of the information. In embodiments, the auction module verifies the information included in the vendor bids prior to its presentation to the customer by comparison with, e.g., profile information (e.g., profile information 70 of the vendors 30) and/or predefined schema indicating allowed information types, formats, terms, values and/or ranges. The presented bids may include each vendor's identification, service type, service subtype, contact information, price, description, restrictions, and/or conditions. This information can be included in a bid and/or retrieved from corresponding vendor information (e.g., profile information 70). The description information may identify credentials, ratings, friends, and/or non-profit organizations supported by the vendor. Based on this information, the customer may identify mutual connections and/or causes that may differentiate the vendor's bid on bases other than, for example, cost. Further, auction module may automatically identify mutual relationships common to the customer and the bidding vendors and incorporate links (e.g., hyperlinks) to the representations of the mutual relationships at the one or more social networks (e.g., social networks 45). By doing so, the customer can contact a relationship that has knowledge of a particular vendor to, for example, obtain a recommendation.

In accordance with aspects of the invention, the vendor's price can be a fixed value or a range. If the bid from a vendor includes a price range, in accordance with aspects of the invention, the user may pay the lower value of the range up front and pay any additional costs up to the maximum value of the range after the service job is complete. By doing so, the vendor will receive, at least, the minimum value for a service and the user is protected from the risk that vendor's costs exceed the range on the high end.

Further, in accordance with aspects of the invention, the vendor's bid may include a donation to one of the non-profit organizations (e.g., non-profit organizations 40) associated with the online service marketplace. For example, when the service request identifies a non-profit organization and/or a donation amount, a vendor may chose to donate to the identified non-profit organization to differentiate the vendor's bid and make it more appealing to the customer. Alternatively, when the service request does not identify a non-profit organization, a vendor may obtain information about the non-profit organization's supported by the customer based on relationship information included in customer's profile information (e.g., in profile information 70) and/or included in a profile of the customer in a online social network (e.g., online social networks 45).

According to aspects of the invention, the auction module allows vendors to ask questions about the customer's service request, and for the customer who created the request to answer the questions. In implementations, the auction module presents these questions and/or answers to the customer and vendors alongside displayed bids. For example, perhaps one hairdresser has a question regarding the length of the hair to be cut. The system enables the hairdresser to ask this question through a computer providing a computer-user interface (e.g., provided at computer terminal 32 via host 50) and the system, similarly, allows the customer to answer (e.g., via terminal 22). The display of the bids presented by customer's terminal can present both the question and the answer.

At step 235, the auction module receives the customers' selection of one of the vendors' bids presented at step 230. In embodiments, the auction module automatically selects a bid based on a reverse auction. Reverse auctions are transactions in which vendors compete to obtain business from the requestor by progressively decreasing prices in effort to underbid other vendors. The auction can include real-time communication between potential buyers and vendors via multiple channels, and the bidding can be both manual and automatic. Via the manual mode, a vendor participates by submitting one bid in response to bids from other vendors. Via the automatic bids (i.e., auto-bid), the vendor defines the lowest price at which he is willing to sell, and the system continually bids for that vendor until either the buyer selects and purchases a bid or the seller's lowest price is exhausted. The auction module presents the bids to the customer on the customer's computing device and receives the customer's selection for purchase. The auction module provides information related to the selected bid to a payment module (e.g., payment module 86) for completion of the purchase from the vendor that provided the selected bid.

Additionally or alternatively, in embodiments, the direct-buy (i.e., direct purchase) options are presented to the customer. A direct-buy option is an offer to perform the requested service at a specified price without participating in an auction. In such case, the online service marketplace (e.g., request module 80) may match the customer's service request with bids for vendor services including a direct-buy option.

The payment module releases the payment for the purchased service to the vendor selected at step 235. Payments may be in the form of currency, credit, or coupons. In embodiments, the payment module transmits data to, for example, a third-party payment gateway, which handles the credit-card transaction. The payment module may, for example, retrieve pre-stored (e.g., in profile information 70) payment information of the customer and/or the selected vendor.

At step 240, in accordance with aspects of the invention, the payment module determines whether the customer and/or the selected vendor has elected to enter a donation to a non-profit organization (e.g., non-profit organization 40). In embodiments, users can donate while purchasing a service transaction, or use the system to donate directly to causes, unaffiliated with a service transaction. Ideally, both methods of donation channel one hundred percent of donations to the charitable causes. Users can donate only to non-profit organizations (e.g., charitable causes) that have elected to participate in the online service marketplace. If the customer and/or the selected vendor elect to donate to a non-profit organization, at step 242, the online service marketplace determines the customer's and/or the selected vendor's selection of a non-profit organization and donation amounts. For example, the customer and/or the selected vendor enter an optional donation (i.e., a monetary gift), to a given cause, which is displayed in a user interface that displays all these details.

At step 246, the payment module releases the donation to the selected non-profit organization determined in step 242. In embodiments, the online service marketplace transmits data to, for example, a third-party payment gateway, which handles the credit-card transaction. In accordance with aspects of the invention, the payment module attributes the fees of the transaction through the third-party payment gateway to the customer and/or the selected vendor such that the entire donation amount is provided to the selected non-profit organizations. After releasing the donation, the process returns to the main process flow at step 250.

In embodiments, the payment module aggregates payments due to the vendors and/or the non-profit organizations. For example, at specified intervals, the payment module (e.g., payment module 86) sends payments to specific vendors and/or the non-profit organizations. For example, a hairdresser has completed ten haircuts through the system in the past two weeks, and the specified interval (defined in the system's terms of use) is two weeks. At the end of this period, the vendor receives payment for all ten haircuts from the account. Upon receiving payment, the vendor can, via the payment module, enter an optional donation to the non-profit organization, which the payment module allows the vendor to choose, for example, via a computer-user interface provided on the vendor's computer (e.g., computer terminal 32), which the user interface enables the vendor to search. If applicable, the payment module sends donation to the non-profit organizations.

At step 250, after completion of the service selected in step 235, the history module (e.g., history module 88) receives the customer's approval of the completed service. In embodiments, the history module may present a graphical-user interface on the customer's computing device (e.g., computer terminal 22) including entries enabling the customer to provide an approval of the completed service.

At step 255, the history module determines whether the customer and/or the selected vendor elects to share the purchase and/or donation information on social media (e.g., online social networks 45). In embodiments, the history module can present a graphical-user interface on the customer's computing device (e.g., computer terminal 22) and/or the vendor's computing device via which the customer and the vendor can indicate their selections of some or all of the purchase information and/or donation information. For example, the customer or the selected vendor may elect to share only donation information. If the customer or the vendor elects to share the purchase and/or donation information at step 255, then at step 260, the history module posts the information to one or more of the customer's and/or the selected vendor's representations (e.g., online representations 47) in an online social networking service (e.g., social network 45).

At step 265, the history module receives notification of fulfillment of the purchased service. At step 270, the history module updates the history of the customer and/or the selected vendor. In embodiments, the customer and/or the vendor rate the other party. For example, the history module can provide graphical-user interface that presents an option for the customer and the vendor to submit a rating of the other party (e.g., on a one-to-five scale). The history module may store the ratings in association with the customer's and/or the vendor's user profile (e.g., profile information 70) and/or post the information to the customer's and/or the vendor's representations (e.g., online representations 47).

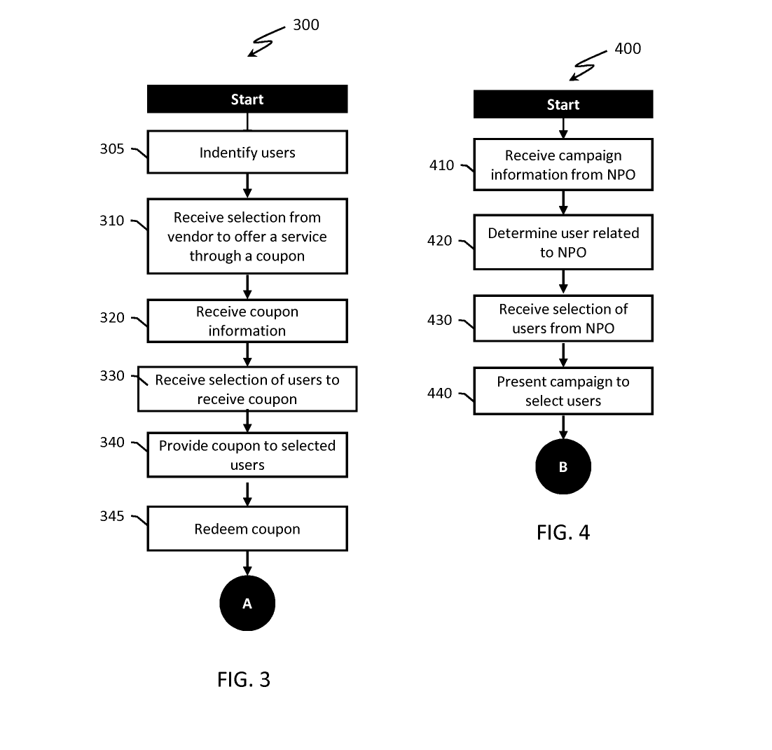

FIG. 3 shows a flow diagram of exemplary processes for issuing and using coupons in an online service marketplace in accordance with aspects of the present invention. In embodiments, the coupons are electronic certificates (i.e., a voucher) entitling other users of the online service marketplace (i.e., customer 20, vendors 30, and non-profit organizations 40) to purchase a service from a vendor at a discount. In implementations, the vendor issues the coupons to users via the online service market place (e.g., host 50), which issues and redeems the coupons. By providing coupons through the online service marketplace, vendors can target their marketing to potential customers with purchase histories that indicate potential interest in a given vendor's services, including only targeting customers who have never purchased from the vendor before. Additionally, vendors can capitalize on the invention's social media platform focused on work and philanthropy to market virally selected coupons and offers.

A vendor (e.g., one of vendors 20) may access the online service marketplace (e.g., host 50) and initiate a coupon module (e.g. coupon module 90) via a computer-user interface provide at a computing device (e.g., computer terminals 32). At step 305, a coupon module (e.g., coupon module 90) identifies potential customers (e.g., customer 20). Via the coupon module 90, the vendor can submit criteria to identify potential customers. The criteria can be any information associated with a user's profile (e.g., profile information 70), such as demographics, location, credentials, recommendations, purchase history, payment history, donations history, and social media information (e.g., associated online social networks, online social network memberships, representations, relationships, etc.). For example, the vendor may submit criteria to have the coupon module 90 identify users of the online service marketplace within a particular range of the vendor's location that have never used the vendor's service. Additionally, in accordance with aspects of the invention, the coupon module may identify users based on relationship information of the customers obtained from online social networks (e.g., online social networks 45). For example, the vendor may provide coupons to a particular user when the user's online representation has a direct (e.g., mutual) or indirect link to the vendor's online representation.

At step 310, the coupon module receives selections of users identified in step 305. At step 320, the coupon module receives information about the coupon from the vendor, such as a desired requested percentage off the normal price, time limits, and conditions. The coupon module stores the received information (e.g., as coupon information 76) in association with the vendor's profile (e.g. profile information 70). At step 330, the coupon module receives the vendor's selection of a set of users that the vendor would also like to offer the coupon. The identities of the selected set of users may be stored in association with the coupon information for reference redemption, payment, and tracking purposes. For example, based on the stored coupon information, the coupon module prevents a particular user from redeeming a coupon more than once.

At step 340, the coupon module provides the coupon to the set of users selected by the vendor in step 330, and displays it on the user interface for those customers. For example, the coupon module can send each of the selected users a message including the coupon from the vendor. At step 345, the coupon module may redeem the coupon provided to one of the selected users (e.g., customer 20). The coupon may include a code or hyperlink that, when provided to the online service marketplace by a consumer, causes the coupon module 90 to redeem the coupon. For example, the coupon module may cause the user's computer terminal to enter to enter the process flow of FIG. 2 at step 240.

FIG. 4 shows a flow diagram of exemplary processes providing charitable campaigns in an online service marketplace in accordance with aspects of the present invention. Using the online service marketplace, via a campaign module (e.g., campaign module 92), non-profit organizations (e.g., non-profit organizations 40) can develop specific campaigns for which to raise funds or receive service donations via the online service market place (e.g., host 50). For example, a non-profit organization can raise funds for the whole organization and/or for specific causes, such as disaster relief for a particular storm. The campaign module can also match vendors (e.g., vendors 30) who would like to volunteer services free of charge with campaigns, causes, and charitable organizations that require these services to foster multiple modes of online communication (including messaging, posting questions and answers, and file-sharing). Additionally, the campaign module can create a database of causes and nonprofits to which both buyers and vendors can donate.

A non-profit organization (e.g., one of non-profit organizations 40) may access the online service marketplace (e.g., host 50) and initiate a campaign module (e.g. campaign module 92) via a computer-user interface provide at a computing device (e.g., similar to computer terminals 22 ad 32). In accordance with aspects of the invention, at step 410, the campaign module receives information about a campaign from the non-profit organization. The campaign information may include, for example, identification of the non-profit organization, a description of the campaign, a campaign goal (e.g., fundraising amount, desired services), and time constraints. The campaign module stores the received information (e.g., as campaign information 78) in association with the non-profit organization's profile (e.g. profile information 70).

At step 420, the campaign module determines users related to the non-profit organization. In embodiments, the campaign module retrieves profile information 70 of users that have affiliated themselves with the non-profit organization (e.g., online social network 45).

At step 430, the campaign module receives selections of users retrieved in step 420 from the non-profit organization. For example, the campaign module may present a computer-user interface through which the non-profit organization can browse and select users based on the user's profile. At step 440, the campaign module provides campaign information to the users (e.g., customer 20 and vendors 30). Based on the received campaign information, a customer can donate directly to the non-profit organization. Additionally or alternatively, the customer may participate in the campaign by purchasing a service to be performed by a vendor for the non-profit organization entering the process flow at step 210 of FIG. 2.

Aspects of the invention offer an efficient way for costumers to obtain services from vendors by aggregating service transactions to enable online transactions for any type of service. Additionally, aspects of the invention advantageously enable worldwide communication between users so that they could both offer and purchase any and all services by communicating in informal and immediate ways. Further, aspects of the invention advantageously bring together charitable causes while allowing users to donate to specific, chosen causes. By linking donations to service transactions, users, people donate more. Moreover, by simultaneously also enabling users to donate to any and all charitable causes, users can obtain and support the causes about which they care. In further aspects of the invention, the marketplace provides vendors with market research. For example, the system could notify vendors of particular geographic areas where a given service is especially popular. The system would also allow vendors to offer coupons to targeted demographics identified through such data.

As disclosed herein, embodiments and features of the invention can be implemented through computer hardware and/or software. Such embodiments can be implemented in various environments, such as networked and computing-based environments with one or more users. The present invention, however, is not limited to such examples, and embodiments of the invention can be implemented with other platforms and in other environments.

Moreover, while illustrative embodiments of the invention have been described herein, further embodiments can include equivalent elements, modifications, omissions, combinations (e.g., of aspects across various embodiments), adaptations and/or alterations as would be appreciated by those in the art based on the present disclosure. Other embodiments of the invention will be apparent to those skilled in the art from consideration of the specification and practice of the embodiments of the invention disclosed herein. It is therefore intended that the specification and embodiments be considered as exemplary only.

What is claimed is:

1. A method for providing an online marketplace for services from vendors comprising:
providing a request for a service received from a customer to a plurality of the vendors;
receiving a plurality of bids from the plurality of vendors in response to the request for the service;
receiving a selection of one of the plurality of bids from the customer; and
providing a payment to a selected vendor of the plurality of vendors corresponding to the selected one of the plurality of bids.

2. The method of claim 1, further comprising generating the request for the service from a set of unconstrained terms received from the customer.

3. The method of claim 1, wherein the payment includes a donation to one of a plurality of non-profit organizations registered with the online marketplace.

4. The method of claim 3, wherein the request for the service specifies the donation.

5. The method of claim 3, wherein:
the payment includes a transaction fee and the donation, and
the providing the payment comprises providing an entire amount of the donation to the one of a plurality of non-profit organizations.

6. The method of claim 1, wherein the request for the service includes information identifying relationships of the customer in one or more online social networking services.

7. The method of claim 1, wherein at least one of the bids is automatically generated in response to the request for the service.

8. The method of claim 1, further comprising managing a reverse auction among the received plurality of bids.

9. The method of claim 8, wherein:
a first of the plurality of bids is a continuous bid that specifies an opening bid and a minimum bid; and
managing the reverse auction comprises progressively lowering a value of the continuous bid from the opening bid to the minimum bid.

10. The method of claim 1, wherein one or more of the plurality of bids identifies mutual relationships between the customer and the vendor in one or more online social networking services.

11. The method of claim 10, wherein the method further comprises posting information associated with the purchase to an online representation of the mutual relationships common to both the customer and the vendor in the one or more of the online social networks.

12. The method of claim 1, wherein:
the bid specifies a price range for the service between a lower value and an upper value; and
the providing the payment comprises receiving an agreement from the customer to pay the lower value upfront and to pay any additional cost of the service up to the maximum value of the range after the service is complete.

13. The method of claim 1, wherein the payment for the purchase includes a coupon received from one of the plurality of service vendors.

14. A system for providing an online marketplace for services from vendors comprising:
a computing system comprising one or more computing devices communicatively linked via an information network, wherein the one or more computing devices:
provide a request for a service from a customer to a plurality of service vendors;
receive a plurality of bids from the plurality of service vendors in response to the request for the service, one or more of the plurality of bids indicating a mutual relationship with the customer in an online social network;
receive a selection of one of the plurality of bids indicating the mutual relationship for purchase; and
complete the purchase of the service.

15. The system of claim 14, wherein the request for the service specifies a donation.

16. The system of claim 14, wherein the request for the service includes information identifying relationships of the customer in one or more online social networking services.

17. The system of claim 14, wherein the one or more computing devices automatically generate at least one of the plurality of bids in response to the service request.

18. The system of claim 14, wherein the one or more computing devices manages a reverse auction among the received plurality of bids.

19. The system of claim 18, wherein managing the reverse auction comprises progressively lowering a bid value from the opening bid to the minimum bid based on competing bids.

20. The system of claim 14, wherein the one or more computing devices posts information associated with the purchase to the mutual relationship.

21. The system of claim 14, wherein the payment for the purchase includes a coupon received from one of the plurality of vendors.

22. A computer program product comprising a computer usable storage medium having readable program code stored on a computer-readable storage device that, when executed by one or more computing devices, control one or more computing devices to:
receive a plurality of bids from a plurality of service vendors in response to a request for a service from a customer, one or more of the plurality of bids indicating a mutual relationship with the customer in an online social network;
receive from the customer a selection of one of the plurality of bids indicating the mutual relationship for purchase; and
post information associated with the purchase to a representation of the mutual relationship in one or more online social networks.

23. The computer program product of claim 22, wherein the request for the service specifies the donation.

24. The computer program product of claim 22, wherein the request for the service includes information identifying relationships of the customer in one or more online social networking services.

25. The computer program product of claim 22, wherein the one or more computing devices automatically generate at least one of the plurality of bids in response to the service request.
